(19) United States
(12) Patent Application Publication
(10) Pub. No.: US 2020/0049508 A1
(43) Pub. Date: Feb. 13, 2020

(54) APPARATUS AND METHODS FOR ELECTRONIC NAVIGATIONAL ROUTING

(71) Applicant: Navionics S.r.l., Milano (IT)

(72) Inventor: Giuseppe Carnevali, Genova (IT)

(21) Appl. No.: 16/342,288

(22) PCT Filed: Oct. 17, 2017
(86) PCT No.: PCT/IB2017/056444

§ 371 Date: Apr. 16, 2019

Related U.S. Application Data
(60) Provisional application No. 62/409,471, filed on Oct. 18, 2016.

(51) Int. Cl. G01C 21/20; G01C 21/36; G01C 21/34

(52) U.S. Cl. CPC G01C 21/203; G01C 21/3664; G06F 3/0488; G01C 21/3614; G01C 21/3415; G01C 21/3423

(57) ABSTRACT

An electronic navigational router includes a processor and a user interface for receiving input from a user and outputting information to a user. The processor is configured to determine whether input from a user is touch input. If the input is touch input, the processor determines whether the touch input is indicative of a touch input that corresponds to a route request from a user. If the touch input is a route request from a user, to the processor develops a route from the user's current location to the location corresponding to that indicated by the touch input and passes the developed route to the user interface, the user interface being configured to display the route developed by the processor.

### RELATED APPLICATIONS

The present application is a U.S. National Stage filing under 35 U.S.C. § 371 of co-pending International Patent Application No. PCT/IB2017/056444, entitled “Apparatus and Methods for Electronic Navigational Routing,” having an International filing date of Oct. 17, 2017, designating the United States and published in English on Apr. 26, 2018 as publication WO 2018/073744, which claims the benefit of U.S. Provisional Patent Application No. 62/409,471, entitled “Apparatus and Methods for Electronic Navigational Routing,” filed on Oct. 18, 2016. The contents of the above referenced applications are incorporated herein by reference in their entirety.

### BACKGROUND

Inventive concepts relate to navigational devices and, more particularly, to navigational routers, and methods for performing navigational routing.

Computers of one form or another have been employed by mankind for thousands of years. The Antikythera mechanism, an ancient mechanical form of analog computer, was used by the Greeks two thousand years ago to predict astronomical positions and eclipses. Various forms of analog computers, which, generally, employ continuously changeable aspects of physical phenomena to model a problem and solution, have been used in weapons systems for fire control, bomb sights, and other complex military and scientific tasks. Digital computers now dominate the computer field, having moved to the forefront in the latter half of the twentieth century. Along with the dramatic increases in circuit densities in digital technologies and corresponding increased utility, digital computers of various sorts have become ubiquitous, being employed for everything from the most complex weather, financial, or nuclear weapons modeling at one extreme, to simple, quotidian tasks, such as exchanging email messages at the other extreme. Neural networks may be implemented in analog, digital, or hybrid form and may tackle problems, such as pattern recognition, that may not be readily susceptible to solution using conventional digital computers.

The utility of computers has evolved in kind and in extent. From addressing obscure and theretofore intractable problems, such as astronomical tracking in ancient times, to the commonplace of determining the current time via a cellular telephone, computers have evolved to solve far more problems at all levels of complexity, for a much wider variety of users. Users have evolved from a tiny priesthood of experts schooled in the arcana of their machines to almost universal usage by young and old alike. Going hand-in-hand with the profusion of users, is the seismic shift in computers' ease of use.

Without programming, a computer, whether analog or digital, mechanical or electronic, would be of little use, except, perhaps, as a paperweight or wall decoration. Programming, in fact, transforms a useless pile of gears (in the case of the Antikythera mechanism), a collection of vacuum tubes or an array of operational amplifiers (analog computers), front panel switches and discrete circuits (early digital computers), or vastly complex arrays of silicon circuits (contemporary electronic devices), into useful, functioning machines.

Although it is true that a far greater number of people are familiar with and conversant with their uses, in order to expand the pool of users, and make the utility of computers available to a broader sampling of people, designers strive to simplify the user's interaction with computers. In fact, it is estimated that fully 75% of all research and development in the computer arena is spent on improving the usability, the user-friendliness, of electronic devices, such as a computer.

Another ancient art is that of navigation, and it, too, has undergone a dramatic transformation. From vellum nautical charts kept under lock and key in a sea-chest, sextants and chronometers to determine the current location of a vessel, and dividers employed to plot and check a route according to the chart, to electronic devices that employ satellite navigation for the current location of a vessel and overlay that position on an electronic image of a digitized chart along with route-development applications that allow a user to employ electronically-obtained location and chart information to plot and follow a route, navigation has similarly transitioned from an arcane art to a process employed by millions every day.

However, navigational route-development, may still require more user interaction than would be ideal and many users may find a simpler form of navigational route developer useful.

### SUMMARY

Example embodiments in accordance with principles of inventive concepts include a marine electronic system (which may include an electronic navigational router, a plotter, fish finder, or other electronic marine navigational aid) that includes a graphical user interface including an input device and a display, a processor to control the display to display marine cartographic information, the processor further configured to accept a touchscreen input from a user and to generate a route from a vessel's current location to the location indicated by the input from the touchscreen.

In an aspect, an electronic navigational router includes a processor and a user interface for receiving input from a user and outputting information to a user. The processor is configured to determine whether input from a user is touch input. If the input is touch input, the processor determines whether the touch input is indicative of a touch input that corresponds to a route request from a user. If the touch input is a route request from a user, to the processor develops a route from the user's current location to the location corresponding to that indicated by the touch input and passes the developed route to the user interface, the user interface being configured to display the route developed by the processor.

In some embodiments, the processor is configured to determine the current location of the navigational router and to develop a route from the navigational router's current location to the location indicated by a user's touch input.

In some embodiments, the processor is configured to determine the current location of the navigational router and to develop a nautical route from the navigational router's current location to the location indicated by a user's touch input.

In some embodiments, the processor is configured to determine the current location of the navigational router and to develop a terrestrial route from the navigational router's current location to the location indicated by a user's touch input.

In some embodiments, the processor is configured to determine the current location of the navigational router and to develop an aviation route from the navigational router's current location to the location indicated by a user's touch input.

In some embodiments, the processor is configured to determine the current location of the navigational router and to develop a route from the navigational router's current location to the location indicated by a user's touch input, wherein the route is a combination of at least two from the group of: terrestrial, nautical, aviation routes.

In some embodiments, the processor is configured to determine the current location of the navigational router and to develop a route from the navigational router's current location to the location indicated by a user's touch input, to monitor the location of the navigational router and to recalculate the route if the navigational router strays from the route developed by the navigational router by more than a threshold amount.

In some embodiments, the processor is configured to determine the current location of the navigational router and to develop a nautical route from the navigational router's current location to the location indicated by a user's touch input, wherein processor is configured to develop a nautical route by employing measured water depth information to develop marine navigational routes; and the user interface accepting user touch input regarding the end point of a marine route, wherein the electronic route developer is configured to: automatically develop a route based upon the user-supplied end point; discretize into uniform square discretized cells a multidimensional region that encompasses start and end points with nodes placed in cells, each node connected with its neighbors; and develop a marine route that includes at least one intervening waypoint when the end point and a start point are not points of navigable visibility to one another, wherein the electronic router includes water depth measurements in a determination of navigable visibility.

In some embodiments, the router is configured to: extract potential waypoints from cartographic data representing a region that encompasses user-supplied start and end points.

In some embodiments, the route developer is configured to associate a node with each discretized cell within the region and to connect each node with its neighbors with bidirectional edges.

In some embodiments, the route developer is configured to develop a set of candidate nodes based upon points of navigable visibility.

In some embodiments, the route developer is configured to generate candidate nodes and select a node from among the candidate nodes to be a selected node based upon the cost of a link between currently selected node and the candidate nodes.

In some embodiments, the route developer is configured to: generate candidate nodes; and develop a route using start and end points and nodes selected from among candidate nodes based on least-cost to complete the route between start and end nodes.

### BRIEF DESCRIPTION OF THE DRAWINGS

Example embodiments in accordance with principles of inventive concepts will be more clearly understood from the following detailed description taken in conjunction with the accompanying drawings in which:

FIG. 1 is a block diagram of an example embodiment of an electronic navigational router in accordance with principles of inventive concepts;

FIG. 2 is a flow chart of an example embodiment of a process of developing a navigational route in accordance with principles of inventive concepts;

FIGS. 3A through 3C are illustrations of a route development in accordance with principles of inventive concepts;

FIGS. 4A through 4C are illustrations of a route development in accordance with principles of inventive concepts;

FIG. 5 is a block diagram of an electronic system such as may be employed in an embodiment of a navigational router in accordance with principles of inventive concepts.

### DETAILED DESCRIPTION

Example embodiments in accordance with principles of inventive concepts will now be described more fully with reference to the accompanying drawings, in which example embodiments are shown. Example embodiments in accordance with principles of inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. Like reference numerals in the drawings denote like elements, and thus their description may not be repeated.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements should be interpreted in a like fashion (for example, “between” versus “directly between,” “adjacent” versus “directly adjacent,” “on” versus “directly on”). The word “or” is used in an inclusive sense, unless otherwise indicated.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if an element in the figures is turned over, elements described as “bottom,” “below,” “lower,” or “beneath” other elements or features would then be oriented “atop,” or “above,” the other elements or features. Thus, the example terms “bottom,” or “below” can encompass both an orientation of above and below, top and bottom. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments in accordance with principles of inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

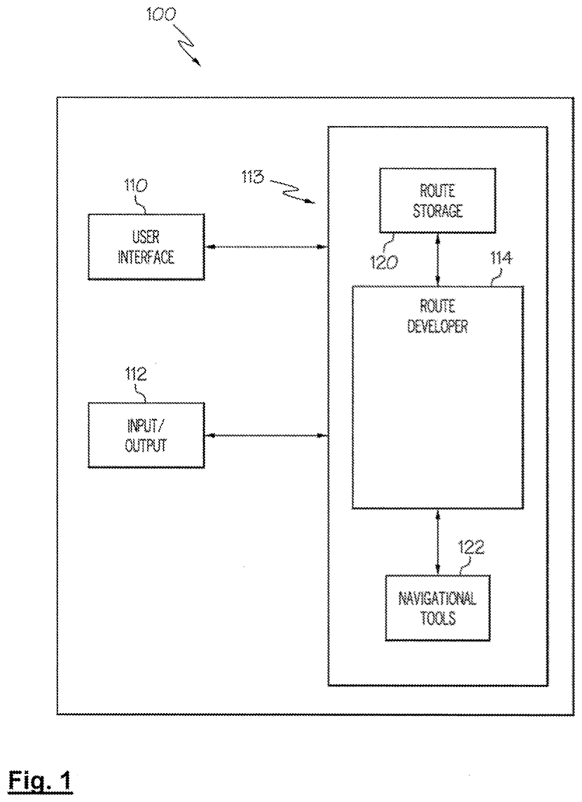

An example embodiment of a navigational routing system 100 in accordance with principles of inventive concepts is depicted in the block diagram of FIG. 1. The navigational routing system 100 includes a user interface 110, and an input/output system 112. A routing subsystem 113 includes a route developer 114. Route storage 120 may be used, in accordance with principles of inventive concepts, to store and retrieve completed routes, either automatically or under the direction of a user, for example.

A route may be stored in route storage 120 and later retrieved by a user, either for direct, immediate use (for example, while cruising), or to be edited in order to develop a different route that may be modified relative to the previously stored route. Information related to geographical and navigational features, such as navigational chart information, point obstructions, navigational buoys, and other man-made obstructions and navigational aids, may be downloaded and stored in the navigational routing system 100. In example embodiments, the download and retrieval of geographical and navigational feature information can occur, wired or wirelessly, via the internet from a host system, for example. This download can take place in real time, so that the feature information is retrieved each time a user performs a route development operation, or can take place offline, so that the entire database of geographical and navigational information is downloaded and stored on the system 100 a single time and always available to a user, even during times when internet access or other communications are unavailable. Navigation tools 122, which may be housed separately from the routing subsystem 113, may operate in concert with routing subsystem 113 to, for example, update the current position, speed, and heading of a user's vessel. Current position of a vessel may be determined, for example, using a satellite location system, such as the global positioning system (GPS), or other geolocation system.

As will be described in greater detail in the discussion related to the following figures, navigational routing system 100 may be implemented on a portable electronic device, such as a dedicated marine navigation system, a laptop computer, a notebook computer, a tablet computer, or smartphone, for example. User interface 110 accepts input from a user and outputs information to a user and may include devices that allow the system 100 to accept user input through voice, touchscreen, keyboard, trackball, joystick, or other device, for example and may also include devices that allow output in the form of displays or audio output, for example.

In accordance with principles of inventive concepts route developer 114 may develop a route from a starting point to ending point that includes a plurality of legs, or links, (that is, reaches between two waypoints, also referred to herein as “nodes,” which may represent waypoints) along the way. User interface 110 may display information related to a plurality of those legs. In accordance with principles of inventive concepts, user interface 110 may also allow a user to input information or commands that allow a user to select a point on a displayed map and automatically produce a route from the device's current location to the point selected on the displayed map. The endpoint may be selected by “touch sensing” using touchscreen sensing, which may employ a touchscreen sensing technology, such as resistive, surface acoustic wave, capacitive, infrared, optical, or acoustic pulse, but inventive concepts are not limited thereto. In example embodiments, a touch for the purpose of indicating a route endpoint may be distinguished from other touches by the duration of the touch. That is, in example embodiments a user may select an endpoint by touching a location and lingering on that location for a relatively long period of time. In example embodiments, if a touch is sustained for a period of at least 0.5 seconds, the route developer determines that the lingering touch is indicative of a route endpoint, but embodiments in accordance with principles of inventive concepts are not limited thereto.

Allowing a user to plot a route by simply touching their intended destination on a display affords a user a great deal of ease in the development of a route. The user simply points to where they want to be, and the electronic route developer automatically develops a route for the user. Such ease of use, may be of particular benefit while operating a vessel, allowing a user to attend to the many tasks that may arise while aboard a vessel, while, at the same time, generating a course forward. As indicated above, approximately seventy-five percent of research and development efforts are now devoted to making a device easier to operate, more user-friendly, and such efforts are particularly beneficial in the realm of navigation.

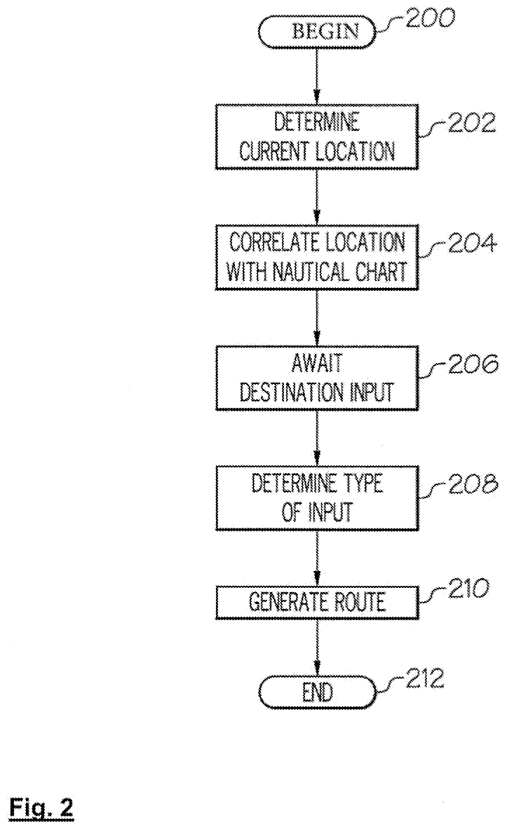

The flow chart of FIG. 2 depicts an example embodiment of a navigational routing process in accordance with principles of inventive concepts. The process begins in process step 200 and proceeds from there to step 202. In an example process, in step 202 a navigational router in accordance with principles of inventive concepts determines the current location of the navigational router (that is, the current location of the geolocation device which, in example embodiments, is presumed to be co-located with the navigational router and vessel). Such a determination may be made, for example, through use of a GPS receiver, which may be included within or in communication with, the navigational router.

Once the current location of the vessel is determined, the process proceeds to step 204, where the navigational router correlates the current location of the vessel with a nautical navigation chart. Longitude and latitude coordinates may be “keyed” to one or more charts, which may be of different resolution, or detail, so that, given a set of coordinates, a navigational router in accordance with principles of inventive concepts may retrieve a chart or charts that encompass an area around the coordinates. The navigational router may retrieve a map or chart section (also referred to herein, simply, as “map”) that includes the vessel's current location and which may include land areas bordering on the waters around the vessel.

That is, as charts may cover a very broad area (potentially, the entire world), the navigational router retrieves a chart section that includes the vessel's current location and that provides a reasonable level of detail within the chart section. If the chart section includes too large an area, the device would not be able to supply a sufficiently-detailed level of display to a user. On the other hand, if the chart section includes too small an area, too much detail, the display may not provide a wide enough view of the charted waters to be of use. The level of detail, the resolution, of a map to be displayed may be set to a default value, may be an optional input from a user, or may be manipulated by touch-screen “pinching” or “widening” of fingers in contact with a touchscreen display included in interface 110, for example. As a route is developed by the navigational router, displaying greater chart detail may be useful for a user and such “zooming in” or “zooming out” may be provided in response to a user prompt (through interaction with a touchscreen, for example) or the router may autonomously zoom in areas that might otherwise generate ambiguity. That is, for example, if a route includes a city, the router may autonomously zoom in for finer detail (either in an inset window or within the main display area) in order to eliminate ambiguity as to which one of a plurality of docks the vessel may employ.

After retrieving a chart associated with the vessel's current location, the process proceeds to step 206 where the navigational router awaits input from a user. This waiting step may be performed in a background mode, occasionally interrupting to check a status flag, while other tasks are performed by the navigational router, for example. When an input is received from a user, the process proceeds to step 208, where the navigational router determines the type of input. In example embodiments, a mode of operation may be established whereby any touchscreen input is assumed to be an indication of a desired route destination, and, as a result, in such a mode a touchscreen input propels the process to step 210, where the navigational router proceeds to generate a route from the vessel's current location to the location indicated by the user's “touch input.” Alternatively, a touch for the purpose of indicating a route endpoint may be distinguished from other touches by the duration of the touch. That is, in example embodiments a user may select an endpoint by touching a location and lingering on that location for a relatively long period of time. In example embodiments, if a touch is sustained for a period of at least 0.5 seconds, the route developer determines that the lingering touch is indicative of a route endpoint, but embodiments in accordance with principles of inventive concepts are not limited thereto.

It is during this process that a navigational router in accordance with principles of inventive concepts may automatically “zoom in” to allow a user to more precisely select from among potential destinations. By allowing a user to select a destination in this fashion (that is, through a single touch of a screen, for example), a navigational router in accordance with principles of inventive concepts is not constrained, at the initial stages, to displaying an entire route, which, if lengthy enough, may prevent the display and interaction with more detailed charts. Such “hands-free” operation affords a great deal of safety and convenience, when compared to conventional approaches. As previously indicated, this, user convenience, is the focus of 75% of research and development spending.

During the process of developing a route, an electronic navigational router in accordance with principles of inventive concepts may employ an automatic rout development, or “autorouting” process, such as one disclosed in U.S. Pat. No. 9,086,278, having the same inventor as the current applicant and entitled, “APPARATUS AND METHOD FOR ROUTING,” which is hereby incorporated by reference in its entirety. After generating a route in step 210, the process proceeds to end in step 212.

Data used in developing a route may be provided by official sources or institutions, such as The National Oceanic and Atmospheric Administration (NOAA), the British Admiralty, The United States Army Corps of Engineers (USACE; for navigable streams and bodies of water within the United States), Basin Authorities (related to specific lakes), or other state or private enterprises, or by users, for example. In example embodiments in accordance with principles of inventive concepts, because shoreline information may vary from time to time, shoreline information may be updated from any of these various sources either automatically or in response to a user's request. That is, shorelines may vary dramatically over time, due to drought, an overabundance of precipitation, or due to scheduled or unscheduled releases of water from an impoundment, for example, that results in a shifting of the shoreline. In accordance with principles of inventive concepts, “official sources” may refer to entities, such as government entities, that are charged with maintaining such shoreline information and who may obtain such information through official surveys that may take place on a regular basis (for example, once a year) or that may be conducted in response to an event, such as a hurricane, that alters shoreline information.

Variations in shoreline information may be accommodated by a system in accordance with principles of inventive concepts. Tidal information, and its effect on the location of a shoreline, for example, may be automatically updated, for example. Updated shoreline information necessary for such adjustments may be obtained by downloading the information from a nearby tide station, from a weather bureau, or from another reporting body, (including other users), for example.

In an example autorouting embodiment, user input is received indicating the endpoint of a desired route with a single touch of a touchscreen input. A geographic area of interest is defined and data structures are initialized. In accordance with principles of inventive concepts the initialization may include a uniform square discretization of a multidimensional region that encompasses the current location (starting point) and end nodes of a route to be developed. The information related to the multidimensional region may be obtained, for example, from charts that characterize a body of water upon which the user intends to travel from starting node to ending node. In accordance with principles of inventive concepts, a node may be placed in every discretized cell and each node connected with its eight neighbors using bidirectional edges. Costs of edges may be assigned as being equal to their Euclidean lengths. Nodes may be generated on the fly and the least-cost (that is, for example, shortest distance) path between starting and ending nodes may be selected as the automatically developed route. In accordance with principles of inventive concepts, in order to reduce computing time and/or memory requirements, various weightings may be applied to the process to obtain sub-optimal results, for example.

In accordance with principles of inventive concepts, the geographic area of interest may be determined by the starting location (also referred to herein as the starting node) and goal, or end, locations (also referred to herein as the end, or goal, node) of a proposed route. Memory use may be minimized by storing data related to only a portion of the geographic area of interest while developing a route, by compressing that data, and by calculating legs, or links, between nodes “on-the-fly,” without storing them. Additionally, due to possibly limited processing power, an automatic routing process may employ suboptimal processing, yielding results that, although not “optimal,” are suitable for use in an automatic routing environment. Additionally, by processing only a portion of a geographic area of interest during each iteration of a Selected Node operation, processing requirements may be further reduced.

In accordance with principles of inventive concepts, data structures initialized in this step include a candidate set, a selected set, and a selected node. The selected node is the node that is currently being developed. That is, in the first iteration, the selected node is the starting node (the node associated with the current location of the vessel), during the second iteration the selected node is the selected in the previous loop, etc. The selected set includes nodes that have been selected during previous iterations during execution of the process. The candidate set includes all the nodes never selected (from among all nodes within the discretized geographic region), and that could still be selected in future iterations.

An autorouter may then select a sub-region around the selected node within the geographic area which encompasses the selected start and end points. As previously described, the selected node is the starting node at the beginning of the automatic routing process. Cartographic vectorial data in the sub-region around the selected node may be analyzed according to navigation rules (for example, avoiding areas of restricted access, such a militarily restricted areas, or area where the user's boats characteristics indicate the boat would be unable to navigate, or an area shallower than a minimum allowable depth) to develop a set of points, referred to as points of visibility (POV), which are used in the node path development.

The points of visibility may be developed by retrieving vectorial data related to the subregion from cartography according to a set of navigation rules. The retrieved vectorial data is then rasterized in order to reduce data complexity. The rasterized vectorial data is then interpreted to extract a geometry meaningful for navigation (that is, geometry that separates navigable from non-navigable regions) in an example embodiment in accordance with principles of inventive concepts. From the extracted/simplified geometry the automatic navigational router may then extract a set of points, points of visibility, that is optimized to minimize, or reduce, the number of points that retain all the important features of the geometry previously extracted. The set many also be further compressed (for example, by ignoring points dividing a lake from land if the user's start and end points are in open sea).

Points of visibility may be developed into a set of candidate nodes. A navigational router in accordance with principles of inventive concepts develops a subset of links between the set of points of visibility previously developed and the selected node (e.g., the start node, at the beginning of the process). To decide which links to create the costs of navigation are analyzed based on an evaluation process, which determines the cost of reaching the candidate node from the selected node. A potential link is checked against the raster data of the cartography and only created if the selected node can “see” the node that would form the other endpoint of the link. That is, the link is only formed if no navigational obstruction lies between the selected node and the point of visibility node in question. For each node in the point of visibility set, the cost of navigation to the selected node is analyzed. If a link is successfully formed between the selected node and a point of visibility node, the related point of visibility node is added to the candidate set of nodes.

When candidate nodes related to the current selected node are developed, the next selected node is chosen from among the set of candidate nodes. In accordance with principles of inventive concepts the chosen node may be the one associated with the lowest cost from the selected node, as determined during the link-creation process, and which also minimizes the linear cost to the end node, and, so on, until the end node (the node indicated by a user's one-touch input for example) is developed.

In example embodiments a user to may enter his boat's draft, height, width, cruising speed, and fuel consumption. For example, in accordance with principles of inventive concepts, in accordance with principles of inventive concepts the option for draft dimensions may be convenience of display (that is, for displaying draft dimensions in a format the user is familiar with) and to coordinate the boat data with charts employed by an automatic navigational router in accordance with principles of inventive concepts or other navigational tools.

An automatic navigational router in accordance with principles of inventive concepts may include a range of values around those entered by a user in order to accommodate different loading situations or, in an alternative embodiment, may use the exact value entered by a user when developing a route. In either case, an automatic navigational router in accordance with principles of inventive concepts may include some margin in the difference between the boat's draft and the water depths provided by cartographic data while developing routes.

Tidal information may also be employed to provide a user with routes that reflect tides (and water levels) at specific times and/or at sub-ranges such as, low tide, high tide, and intermediate levels. Currents, including tidal currents, may also be employed. In some example embodiments cartographic information is stored in object oriented databases and, as a result, point hazards, such as projecting rocks, for example, may not be accounted for in the database and/or in a routing system that employs such a database. However, such point hazards may be included in a database and avoided by an automatic navigational router in accordance with principles of inventive concepts. A global positioning system associated with a router in accordance with principles of inventive concepts may provide speed and heading information, in addition to current location information and, in example embodiments, may be employed by a router in the course of developing a route. Compass readings may also be incorporated into the heading information.

Once a route is developed and a cruise is underway, a navigational router in accordance with principles of inventive concepts may monitor the location, heading, and speed of the vessel, for example, and may recalculate the route (and alert a user) should the vessel stray from course. In example embodiments, a recalculation may not be undertaken unless the vessel strays off course by more than a threshold amount. The threshold amount may be set by a user or may be preset, for example, according to the vessel's characteristics (speed, fuel consumption, etc.).

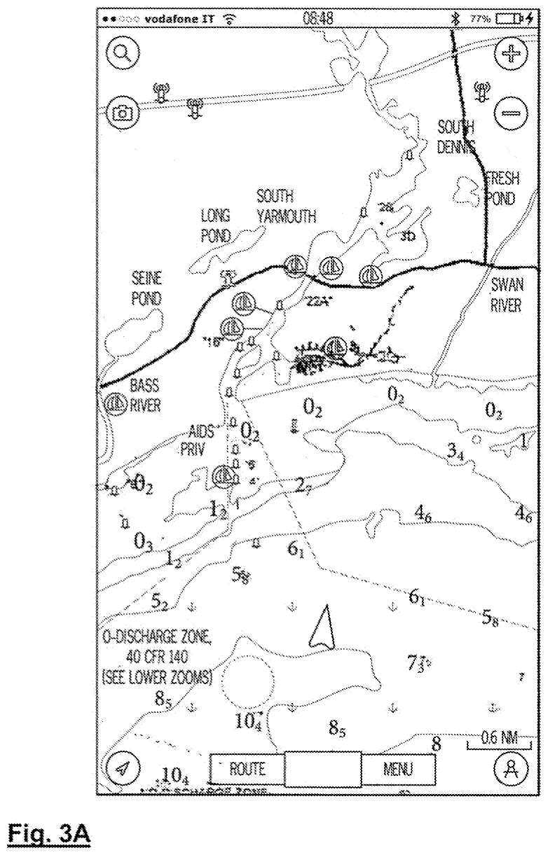

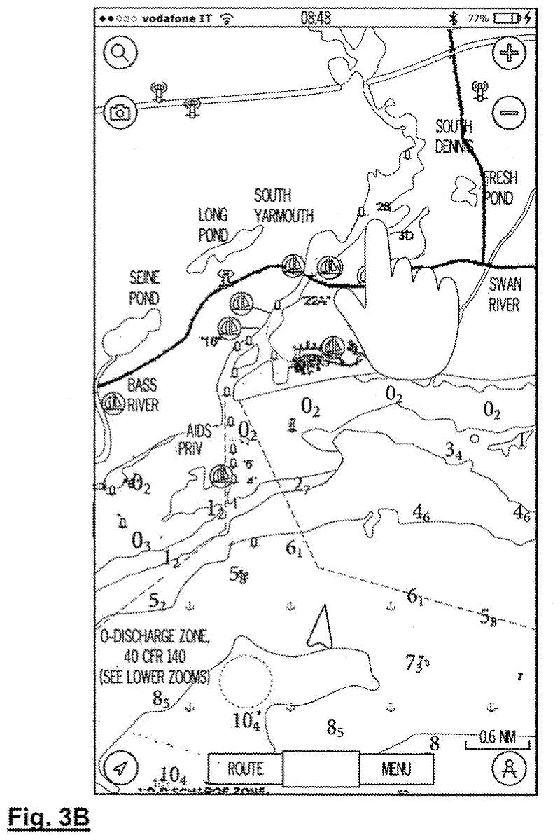

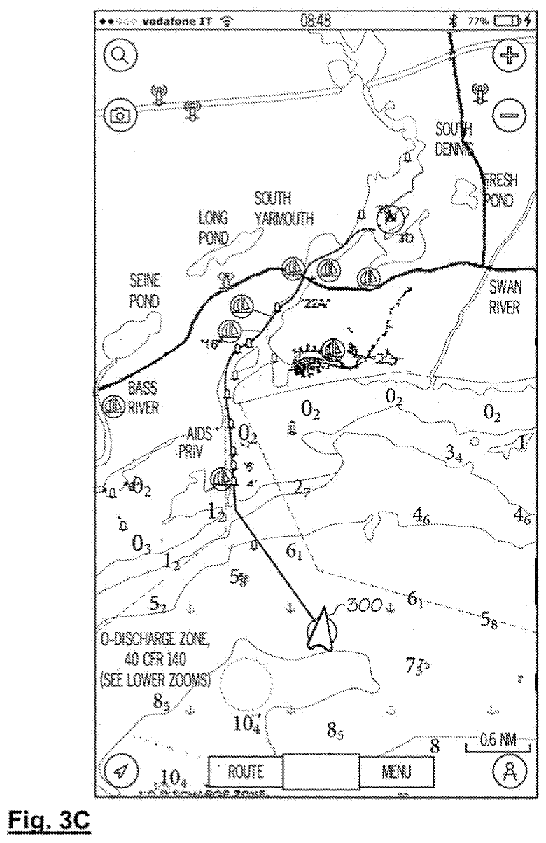

An example of a one-touch route development in accordance with principles of inventive concepts is displayed in the chart displays of FIGS. 3A through 3C. The current location of a vessel is displayed as arrow-shaped icon 300 located offshore of South Yarmouth, Mass., on Cape Cod, as illustrated in FIG. 3A. In this example embodiment the user wishes to obtain a route from their current location to a location up the Bass River. In FIG. 3B, a user touches the display to indicate his desired destination 302, up the Bass River. FIG. 3C illustrates start and end points, or nodes, 300, 302 and the route generated therebetween.

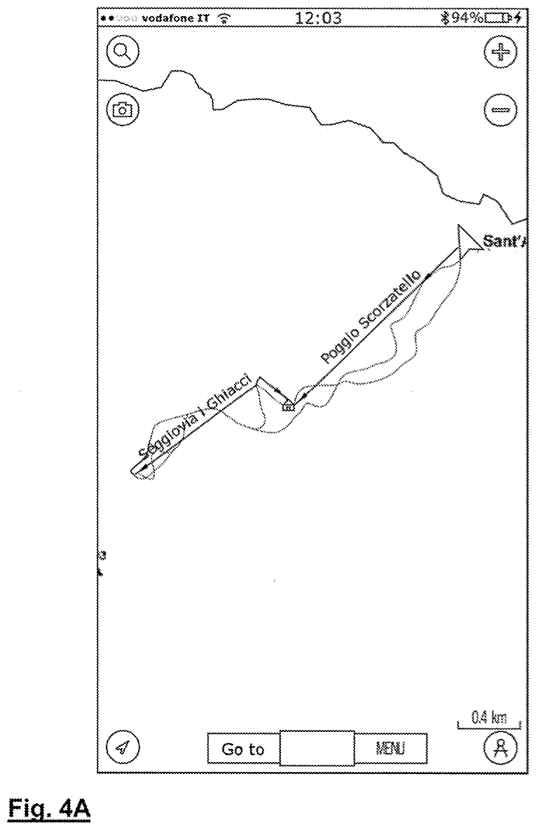

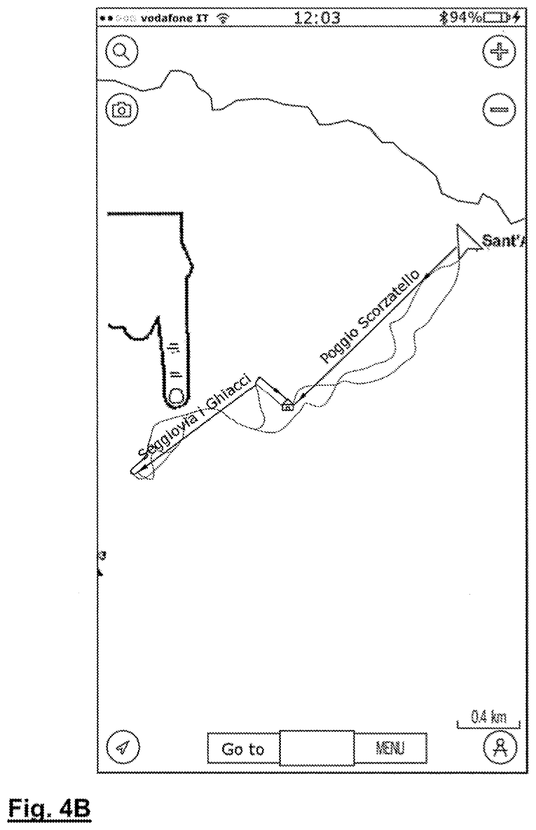

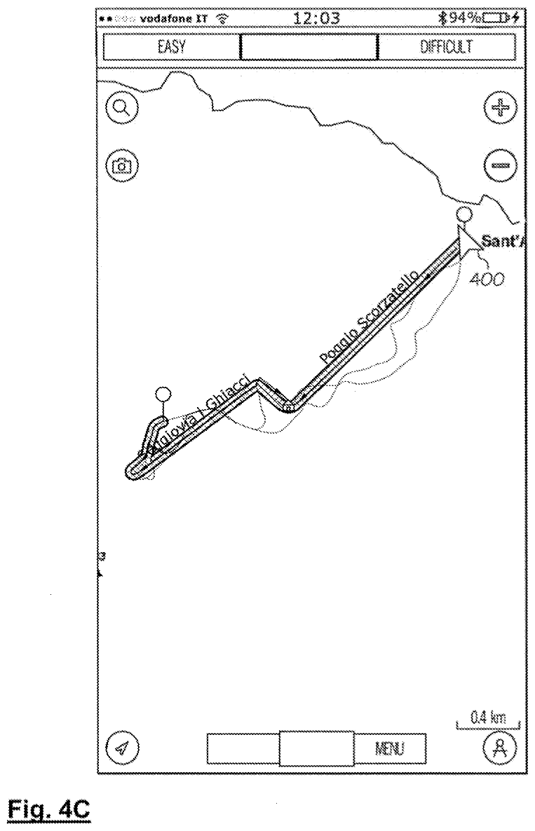

Although, thus far, example embodiments of a “one touch” developer have been described in the context of a nautical application, other realms of application are contemplated within the scope of inventive concepts. One-touch route development may be applied to the development of a route for any mode of transportation, including, but not limited to, land, air, and see, with or without the use of vehicles. Automotive, boating, air-travel, motorcycle, bicycle, pedestrian and other (including, skiing, for example) modes of transportation, both utilitarian and recreational are contemplated within the scope of inventive concepts. For example, a routing system for automotive use is described in U.S. Pat. No. 8,798,917 issued to Rowley et. Al., which is hereby incorporated by reference and a routing system for air travel use is described in U.S. Pat. No. 4,692,869, issued to King, et. Al., which is hereby incorporated by reference. An illustration of the application of inventive concepts to the field of skiing, for example, is given below in reference to FIGS. 4A through 4C.

In the example embodiment of FIGS. 4A through 4C, a skier's current location is indicated by the arrow-shaped icon 400 (FIG.4A), a user indicates his desired destination via touchscreen input 402 (FIG. 4B) (with a single, lingering, touch, for example), and a router in accordance with principles of inventive concepts develops a route therebetween (FIG. 4C).

In the course of developing routes an electronic route developer in accordance with principles of inventive concepts may employ various route-development strategies, including, but not limited to, an autorouting process such as previously described, retrieval of stored routes or tracks, or combinations of such processes. That is, because charts may be somewhat dated, being revised and updated by official agencies only periodically, some areas, particularly areas that are susceptible to change due to prevailing currents or to storm-induced changes, may have radically different characteristics, such as depths, than indicated on official charts. Because boaters may keep a bathymetric record of their trips, which may be referred to as “SONAR tracks,” or simply, “tracks” the tracks may afford a much more accurate view of the actual, current conditions of a body of water.

In example embodiments in accordance with principles of inventive concepts a chart plotter may communicate with a SONAR device to develop and record cartographic information, with longitude and latitude values provided by the plotter and depth values provided by the SONAR device. The resultant track may be formatted and uploaded, for example, to a central repository, where they may be validated, for example, by a service provider. Tracks may be rejected, or invalidated, for example, if the data is corrupted or unreadable, if a date for the track is not provided, if the tracking information relates to an area that is out of a coverage area, or if values appear to be anomalous, with data values that diverge significantly (with the significance threshold determined by the service provider) from established cartographic data. For example, if a track indicates that a certain point has a depth of ten meters, while an established chart indicates that the depth is actually three hundred meters, the track may be invalidated.

In example embodiments in accordance with principles of inventive concepts a navigational router may employ pre-defined routes, or route segments, to create a route for a user. When going from point A to point B a user may download a predefined route, store the route, and follow it during a cruise or may download the route “on the fly” during a cruise.

Various routes may be strung together by a navigational router in accordance with principles of inventive concepts. For example, if a user intends to travel from point A to point D, routes may be available from point A to point B, from point B to point C, and from point C to point D. A navigational router in accordance with principles of inventive concepts will allow a user to download and store all such routes and link them together to provide a route from point A to point D, for example.

In example embodiments in accordance with principles of inventive concepts a system employs a vessel-centric approach to route development. That is, a user may enter attributes of his vessel (for example, draft, beam, etc.) and the system responds to those attributes in the development of routes for the vessel. This is in contrast to an approach whereby a user simply enters information regarding what he considers a safe depth within which to operate. Because a vessel's characteristics may change over time: as fuel is depleted, as stores are added to or depleted from a vessel, as operating speeds change, in example embodiments in accordance with principles of inventive concepts a user may enter and update such vessel-centric characteristics and the system provides safe operating margins for the vessel when developing a route for the vessel. The system allows a user to determine an operating margin, by selecting from a pull-down menu, by directly entering a clearance figure, or by other entry means; takes into account cartographic characteristics (that is, water depths, sea floor hazards, obstructions, weather hazards, etc.), vessel characteristics (draft, vessel type, operating speed, beam, etc.); and automatically, or with user assistance, develops a route for a given set of waypoints entered by the user.

In example embodiments in accordance with principles of inventive concepts a system in accordance with principles of inventive concepts may save routes that have been developed for future use. Such routes may be developed automatically (employing techniques such as those described above for automatically developing routes), may be developed manually, or may be developed using a combination of automatic and manual route-developing techniques. Such routes may be developed using a vessel-centric approach, as described above, or may simply chart-specific techniques whereby a user and/or router employs cartographic information to track minimum depths, for example.

Tracks may be stored by an individual boater or collected and shared, through a central server maintaining a track database, for use in the development of a route. If an exact match between start and end nodes exists in a track data base, that track may be used by an electronic route development system in accordance with principles of inventive concepts, rather than going through the route development process described in the discussion related to FIG. 2. If a stored track provides guidance for only a portion of a route between start and end nodes, the stored track may be combined with an auto-generated portion of a route (in a hybrid, autorouting/stored track combination), or with other stored tracks to provide a route from start to end nodes. Stored tracks may be combined by piecing together overlapping segments of stored tracks, and routes may be “filled in” with autorouted segments where no tracks are available.

As previously indicated, a system in accordance with principles of inventive concepts may continuously monitor the current location of a vessel and, should the vessel stray off-course, recalculate and display a recalculated route (along with heading, speed, and other navigational information) for a user.

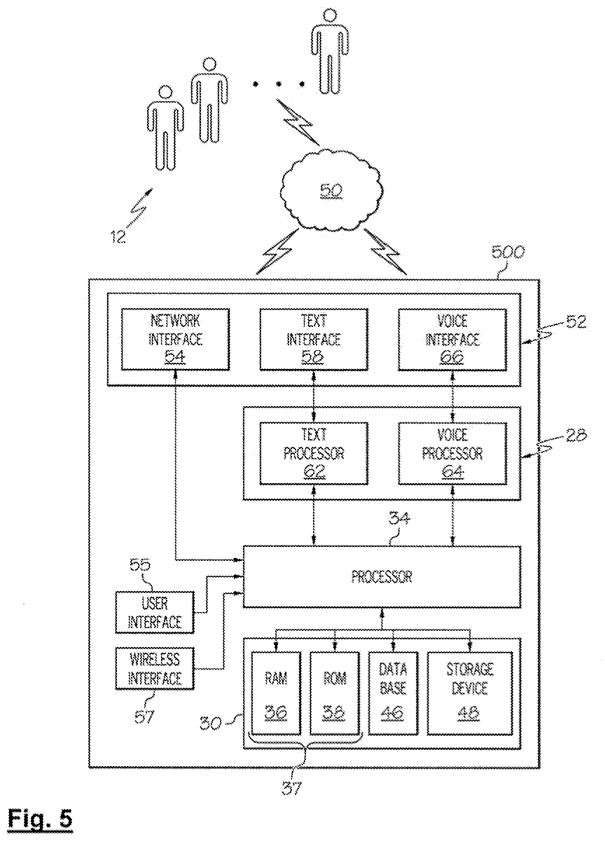

FIG. 5 is an example block diagram of a processing system 500 within which a navigational router (see, for example, FIG. 1) in accordance with principles of inventive concepts may be implemented. The processing system may be included in a personal digital assistant (PDA), a cell phone, a computer, a laptop, a tablet, a terminal, or any other suitable electronic device, whether wired or wireless, for example. The processing system 500 includes at least one processor 34 (e.g., a central processing unit (CPU)) that stores and retrieves data from an electronic information (e.g., data) storage system 30. As will be appreciated by those skilled in the art, while processing system 500 is shown with a specific set of components, example embodiments may not require all of these components and could include more than one of the components that are included, e.g., multiple processors. It is understood that the type, number and connections among and between the listed components are example only and not intended to be limiting.

In the illustrative embodiment, processor 34 is referred to as CPU 34, which may include any of a variety of types of processors known in the art (or developed hereafter), such as a general purpose microprocessor, a bit-slice processor, a digital signal processor or a microcontroller, or a combination thereof, for example. CPU 34 may be operably coupled to storage systems 30 and configured to execute sequences of computer program instructions to perform various processes and functions associated with the navigational router, including the storing, processing, formatting, manipulation and analysis of data associated with the navigational router (e.g., cartographic data, user input, boat specifications, etc.). The computer program instructions may be loaded into any one or more of the storage media depicted in storage system 30.

Storage system 30 may include any of a variety of semiconductor memories 37, such as, for example, random-access memory (RAM) 36, read-only memory (ROM) 38, a flash memory (not shown), or a memory card (not shown). The storage system 30 may also include at least one database 46, at least one storage device or system 48, or a combination thereof. Storage device 48 may include any type of mass storage media configured to store information and instructions that processor 34 may need to perform processes and functions associated with the navigational router. As examples, data storage device 48 may include a disk storage system or a tape storage system. A disk storage system may include an optical or magnetic storage media, including, but not limited to a floppy drive, a zip drive, a hard drive, a “thumb” drive, a read/write CD ROM or other type of storage system or device. A tape storage system may include a magnetic, a physical, or other type of tape system.

While the embodiment of FIG. 5 shows the various storage devices collocated, they need not be as they could be remote to each other, to processor 34 or both. Storage system 30 may be maintained by a third party, may include any type of commercial or customized database 46, and may include one or more tools for analyzing data or other information contained therein. In particular, database 46 may correspond, all or in part, to a cartographic database, and may include tools for matching cartographic data to locations, whether past, present or future, of a user's vessel, and relating that information to navigational systems, as previously described.

In example embodiments, data storage system 30 may be configured to store data representative of the users 12 (and their boats). Data representative of users 12 may include data that is not specific to the navigational router, such as a name, a delivery address, a zip code, a credit card number, a social security number, a phone number, an email address, or a combination thereof, as examples. Data representative of a user may include data associated with the user and the navigational router, such as, type of boat, boat draft, boat height, boat beam, boat weight, a username, a password, a user rating or ranking, a user comment, a member or account number, an access code, community comments regarding navigation, and so on.

As an example, database 46 may include any hardware, software, or firmware, or any combination thereof, configured to store data. Specifically, database 46 may be configured to store data and information representative of one or more of the plurality of users 12, their boats, and cartographic and navigational information. In some embodiments, database 46 may include one or more fields, wherein a field may be an element of a database record in which one piece of information may be stored. In particular, a field may be configured to store an element of data representative of one or more of the users 12.

In some embodiments, one or more storage device in the data storage system 30 (e.g., database 46) may be configured to store cartographic or route data, or other data associated with the navigational router. Data associated with the navigational router 100 may be stored in storage system 30 using any suitable database format, such as, for example, a relational database, a hierarchical database, or any suitable schema. Data storage system 30 may be configured to store information in a format configured to enhance operations of CPU 34 or other functions of the navigational router.

Processing system 500 may include or interface with one or more security systems (not shown), configured to at least partially restrict or control access to one or more components of processing system 500. Security systems may include hardware, software, firmware or a combination thereof, such as, for example, a firewall, password protection software, user authentication software, encryption software and the like. In some embodiments, security systems may be configured to limit a function of the navigational router, limit access to data associated the navigational router, or both.

In some embodiments, processing system 500 may be configured so that select data contained within storage system 30 may be inaccessible to one or more of the users 12.

Processing system 500 may include a network interface system or subsystem 54 configured to enable cartographic data updates, for example. As such, processing system 500 may be configured to transmit or receive, or both, one or more signals related to the functions of the navigational router 100. A signal may include any generated and transmitted communication, such as, for example, a digital signal or an analog signal. As examples, network 50 may be a local area network (LAN), wide area network (WAN), virtual private network (VPN), the World Wide Web, the Internet, voice over IP (VOIP) network, a telephone or cellular telephone network or any combination thereof. The communication of signals across network 50 may include any wired or wireless transmission paths. The navigational router previously described may employ the one or more networks 50, for example.

To enable communications via network 50, processing system 500 may include a set of interfaces 52 and a set of processors 28, 34. The set of processors 28 may include a text processor 62 and a voice processor 64, along with CPU 34. The set of interfaces may include a network interface 54, a text interface 58 and a voice interface 66, as shown in this embodiment. As mentioned above, network 50 may represent a combination of networks configured to transmit and receive communications with processing system 500, via any of the set of interfaces 52.

CPU 34 may be operably coupled to network interface system 54 for exchanging typical computer network information, e.g., via the Internet, a LAN, WAN, VPN or some combination thereof. Network interface system 54 may be configured to permit communication between and among the users 12 and processing system 500, for example using an Internet protocol (IP) or other network-based protocol. In such cases, network interface system 54 may be configured to utilize TCP/IP, HTTP, DNS or any other application, transport, network, or link protocol, or combination of the foregoing.

Text interface 58 may be operably coupled to a text processor 62 configured to process received text message and text messages to be transmitted. Text interface 58 may be configured to permit text-based communication between users 12 and processing system 500. For example, in combination, text interface 58 and text processor 62 may include functionality to communicate with a two-way pager, a personal digital assistant (PDA), a cell phone, a computer, a laptop, a tablet, a terminal, or any other suitable electronic device, whether wired or wireless. Text processor 62 may include an email system configured to transmit, receive, or process, email messages or a combination thereof. Text processor 62 may also include an instant-messaging (IM) system, a two-way paging system or other system configured to transmit, receive, or process, or a combination thereof, text-based information. As will be appreciated by those skilled in the art, such systems may also provide mechanisms for transferring files between devices. Such files may include any of a wide variety of content.

Voice interface 66 may be operably coupled to a voice processor 64 configured to process received voice information and voice data to be transmitted. Voice interface 66 may be configured to permit voice-based communication between and among the users 12 and processing system 500. For example, in combination, voice interface 66 and voice processor 64 may be configured to enable interaction with a cell phone, a fixed-line telephone, a VOIP device or other similar device, or combinations thereof. For example, voice interface 66 may be configured to transmit, receive, or both digital and analog signals using wired to wireless communications devices and systems, such systems may include telephone, cellular telephone and VOIP systems, as examples.

In some embodiments, the operable connections between components of processing system 500 may be other than as shown in FIG. 5. For example, data storage system 30 may be operably connected to communication processors 28 or interfaces 52, or both, such that users from the plurality of users 12 may modify data stored in data storage system 30 using such interfaces and processors. User interface 55, which may include one or more displays, including touch-screen displays, for example, may also include keypad, button, or other input devices, including, in some example embodiments, voice interface 66. User interface may be in addition to network interface 50, for example. Wireless interface may include various technologies, such as Bluetooth technologies that permit a user and/or a navigational router to communicate with other devices including navigational devices, for example, and may be in addition to network interface 54.

In example embodiments, systems that may be associated with the navigational router 100 may include one or more systems configured to provide additional functions associated or useful in conjunction with a navigational routing system. For example, systems associated with the navigational router may include a tracking system (not shown) configured to track the current location and/or heading of a device associated with the navigational router.

It is also contemplated that the navigational router may be implemented using one or more processing systems 500. For example, example embodiments of an navigational router may include a plurality of processing systems 500, components of processing system 500, or other systems associated with the navigational router. Heavy usage may, for example, require relatively high computational power to efficiently operate the navigational router.

While the present inventive concepts have been particularly shown and described above with reference to example embodiments thereof, it will be understood by those of ordinary skill in the art, that various changes in form and detail can be made without departing from the spirit and scope of inventive concepts as defined by the following claims. In particular, although example embodiments of a route developer in accordance with principles of inventive concepts have been described primarily in the context of a nautical application, other realms of application are contemplated within the scope of inventive concepts. One-touch route development may be applied to the development of a route for any mode of transportation, including, but not limited to, land, air, and see, with or without the use of vehicles. Automotive, boating, air-travel, motorcycle, bicycle, pedestrian and other (including, skiing, for example) modes of transportation, both utilitarian and recreational are contemplated within the scope of inventive concepts.

What is claimed is:

1. An electronic navigational router, comprising:
a processor; and
a user interface for receiving input from a user and outputting information to a user, wherein the processor is configured to:
determine whether input from a user is touch input and,
if the input is touch input, determine whether the touch input is indicative of a touch input that corresponds to a route request from a user and,
if the touch input is a route request from a user, to develop a route from the user's current location to the location corresponding to that indicated by the touch input and to pass the developed route to the user interface; the user interface configured to display the route developed by the processor.

2. The electronic navigational router of claim 1, wherein the processor is configured to determine the current location of the navigational router and to develop a route from the navigational router's current location to the location indicated by a user's touch input.

3. The electronic navigational router of claim 1, wherein the processor is configured to determine the current location of the navigational router and to develop a nautical route from the navigational router's current location to the location indicated by a user's touch input.

4. The electronic navigational router of claim 1, wherein the processor is configured to determine the current location of the navigational router and to develop a terrestrial route from the navigational router's current location to the location indicated by a user's touch input.

5. The electronic navigational router of claim 1, wherein the processor is configured to determine the current location of the navigational router and to develop an aviation route from the navigational router's current location to the location indicated by a user's touch input.

6. The electronic navigational router of claim 1, wherein the processor is configured to determine the current location of the navigational router and to develop a route from the navigational router's current location to the location indicated by a user's touch input, wherein the route is a combination of at least two from the group of: terrestrial, nautical, aviation routes.

7. The electronic navigational router of claim 1, wherein the processor is configured to determine the current location of the navigational router and to develop a route from the navigational router's current location to the location indicated by a user's touch input, to monitor the location of the navigational router and to recalculate the route if the navigational router strays from the route developed by the navigational router by more than a threshold amount.

8. The electronic navigational router of claim 1, wherein the processor is configured to determine the current location of the navigational router and to develop a nautical route from the navigational router's current location to the location indicated by a user's touch input, wherein processor is configured to develop a nautical route by employing measured water depth information to develop marine navigational routes; and the user interface accepting user touch input regarding the end point of a marine route, wherein the electronic route developer is configured to: automatically develop a route based upon the user-supplied end point; discretize into uniform square discretized cells a multidimensional region that encompasses start and end points with nodes placed in cells, each node connected with its neighbors; and develop a marine route that includes at least one intervening waypoint when the end point and a start point are not points of navigable visibility to one another, wherein the electronic router includes water depth measurements in a determination of navigable visibility.

9. The electronic navigational router of claim 8, wherein the router is configured to: extract potential waypoints from cartographic data representing a region that encompasses user-supplied start and end points.

10. The electronic navigational router of claim 8, wherein the route developer is configured to associate a node with each discretized cell within the region and to connect each node with its neighbors with bidirectional edges.

11. The electronic navigational router of claim 8, wherein the route developer is configured to develop a set of candidate nodes based upon points of navigable visibility.

12. The electronic navigational router of claim 8, wherein the route developer is configured to generate candidate nodes and select a node from among the candidate nodes to be a selected node based upon the cost of a link between currently selected node and the candidate nodes.

13. The electronic navigational router of claim 8, wherein the route developer is configured to: generate candidate nodes; and develop a route using start and end points and nodes selected from among candidate nodes based on least-cost to complete the route between start and end nodes.
